(19) United States
(12) Patent Application Publication
(10) Pub. No.: US 2003/0169845 A1
(43) Pub. Date: Sep. 11, 2003

(54) X-ray monochromator and X-ray fluorescence spectrometer using the same

(76) Inventors: Makoto Doi, Osaka (JP); Takashi Yamada, Osaka (JP)

Correspondence Address: BIRCH STEWART KOLASCH & BIRCH, PO BOX 747, FALLS CHURCH, VA, 22040-0747, US

(21) Appl. No.: 10/357,430

(22) Filed: Feb. 4, 2003

(30) Foreign Application Priority Data
Mar. 5, 2002 (JP) 2002-058659

(51) Int. Cl. G21K 1/06

(52) U.S. Cl. 378/84

(57) ABSTRACT

To provide an X-ray monochromator capable of providing properly monochromated primary X-rays having a sufficiently high integrated intensity, the X-ray monochromator 4 for use in a X-ray fluorescence analysis for monochromating X-rays 2, emitted from an X-ray source 3, to provide primary X-rays 5 that are subsequently emitted towards a sample 1. The X-ray monochromator 4 is formed by depositing a plurality of layer pairs on a substrate 4c and each being made up of a reflecting layer 4a and a spacer layer 4b, with a plurality of multilayered films 4e including one or a plurality of layer pairs having a predetermined periodic length d, wherein the closer multilayered film 4e is to the substrate 4c, the smaller is set the above described predetermined periodic length d.

### BACKGROUND OF THE INVENTION

1. Field of the Invention

The present invention relates to an X-ray monochromator for use in the X-ray fluorescence analysis for monochromating X-rays emitted from an X-ray source for irradiating a sample to be analyzed, and an X-ray fluorescence spectrometer utilizing such X-ray monochromator.

1. Description of the Prior Art

In detection of a minute quantity of deposits on a sample such as, for example, a silicon wafer by means of a total reflection X-ray fluorescence analysis in which primary X-rays are emitted towards the sample at a minute angle of incidence, the primary X-rays to be emitted towards the sample have to be properly monochromated with a high integrated intensity so that the sample when so excited can emit a sufficiently high intensity of fluorescent X-rays with suppressing background noises. In such case, it is often practiced that X-rays emitted from an X-ray tube of a type utilizing tungsten (W) as a target are monochromated by a multilayered X-ray monochromator of W/Si (reflecting layer: tungsten/spacer layer: silicon) to provide monochromated continuous X-rays of a desired energy that can be used as the primary X-rays. The multilayered X-ray monochromator hitherto utilized in such purpose is of a design in which a single layer pair made up of the reflecting layer and the spacer layer has a thickness, that is, a periodic length that is fixed in a direction of depth and also has a fixed angle of incidence and, accordingly, the energy range (energy width) of the X-rays that can be reflected and, hence, the integrated intensity of the resultant primary X-rays (relative to the energy) is correspondingly limited.

For more accurate analysis, the integrated intensity of the primary X-rays is desired to be sufficiently high to such an extent that an incident increase of the background noises will not adversely affect the analysis.

### SUMMARY OF THE INVENTION

Accordingly, the present invention has been devised to substantially alleviate the foregoing problem and is intended to provide an X-ray monochromator capable of providing properly monochromated primary X-rays having a sufficiently high integrated intensity and also to provide an X-ray fluorescence spectrometer utilizing the X-ray monochromator of the kind referred to above.

In order to accomplish the foregoing objects of the present invention, there is, in accordance with one aspect of the present invention, provided an X-ray monochromator for use in a X-ray fluorescence analysis for monochromating X-rays, emitted from an X-ray source, to provide primary X-rays that are subsequently emitted towards a sample. The X-ray monochromator is formed by depositing a plurality of layer pairs on a substrate and each being made up of a reflecting layer and a spacer layer, with a plurality of multilayered films including one or a plurality of layer pairs having a predetermined periodic length, wherein the closer multilayered film is to the substrate, the smaller is set the above described predetermined periodic length.

With the X-ray monochromator of the structure according to the present invention, the plural multilayered films having the different periodic lengths in the direction of depth thereof reflect the X-rays of the different energies (and, hence, serves as a so-called “super mirror”). Also, since the closer multilayered film is to the substrate, the smaller is set the above described predetermined periodic length, the X-rays having so small an energy as to be easily absorbed are reflected at a location rather shallow from the surface upon which such X-rays impinge and, therefore, the efficiency of reflection as a whole is high. Accordingly, the primary X-rays which have been properly monochromated with a sufficiently high integrated intensity as a whole can be provided, wherefore a more accurate X-ray fluorescence analysis can be achieved and the limit of detection can also be improved. It is, however, to be noted that the number of the multilayered film is preferably within the range of 2 to 4 and each of all these multilayered films is made up of a plurality of layer pairs.

The present invention in accordance with another aspect thereof also provides an X-ray fluorescence spectrometer, which includes an X-ray irradiating unit for irradiating a sample with primary X-rays, which have been monochromated by the X-ray monochromator of the present invention, and a detecting unit for measuring an intensity of fluorescent X-rays emitted from the sample. Even this X-ray fluorescence spectrometer can bring about effects similar to those afforded by the X-ray monochromator of the present invention.

### BRIEF DESCRIPTION OF THE DRAWINGS

In any event, the present invention will become more clearly understood from the following description of a preferred embodiment thereof, when taken in conjunction with the accompanying drawings. However, the embodiment and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a schematic diagram showing an X-ray monochromator according to a preferred embodiment of the present invention;

FIG. 2 is a schematic diagram showing a total reflection X-ray fluorescence spectrometer according to a preferred embodiment of the present invention, in which the X-ray monochromator shown in FIG. 1 is employed;

FIG. 3 is a chart showing results of simulated calculation, in which the integrated reflection intensity of the X-ray monochromator of the present invention, that is exhibited when continuous X-rays are monochromated, is compared with that of the conventional X-ray monochromator;

FIG. 4 is a chart showing results of simulated calculation, in which the reflectivity of the X-ray monochromator of the present invention, that is exhibited when continuous X-rays are monochromated, is compared with that of the conventional X-ray monochromator; and

FIG. 5 is a chart showing a relation between the angle of incidence of primary X-rays and the ratio of the measured intensity of Mo—Kα line, emitted from a sample, that is, a Si wafer having Mo deposited thereon, which were measured with primary X-rays having been monochromated by the X-ray monochromator according to the preferred embodiment of the present invention, relative to that measured with primary X-rays having been monochromated by the conventional X-ray monochromator.

### DETAILED DESCRIPTION OF THE EMBODIMENT

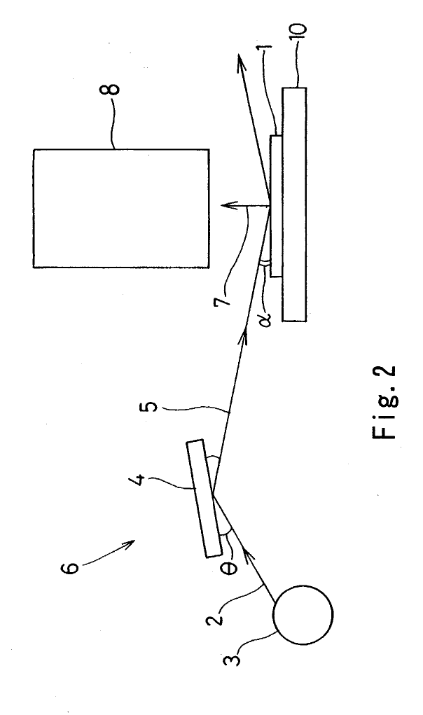

Hereinafter, an X-ray fluorescence spectrometer according to a preferred embodiment of the present invention will be described with reference to the accompanying drawings. As shown in FIG. 2, the X-ray fluorescence spectrometer is in the form of a total reflection X-ray fluorescent spectrometer of a design in which primary X-rays 5 from a X-ray source 3 are emitted towards a surface of a sample 1 at a minute incident angle α which, although shown as exaggerated, may be, for example, about 0.05 degree. This X-ray fluorescence spectrometer includes an X-ray irradiating unit 6 for irradiating the sample 1 such as, for example, a Si wafer placed on a sample support 10, with the primary X-rays 5 which have been monochromated by an X-ray monochromator 4, and a SSD 8 which is a detecting unit for measuring the intensity of fluorescent X-rays emitted from the sample 1 when the latter is excited in response to the primary X-rays. It is, however, to be noted that the X-ray fluorescence spectrometer to which the present invention can be applied is not always limited to the total reflection X-ray fluorescence spectrometer. The X-ray irradiating unit 6 includes the X-ray source 3, that is, an X-ray tube 3 capable of emitting X-rays from a tungsten target in the illustrated embodiment, and the X-ray monochromator 4 for monochromating the X-rays 2 emitted from the X-ray tube 3.

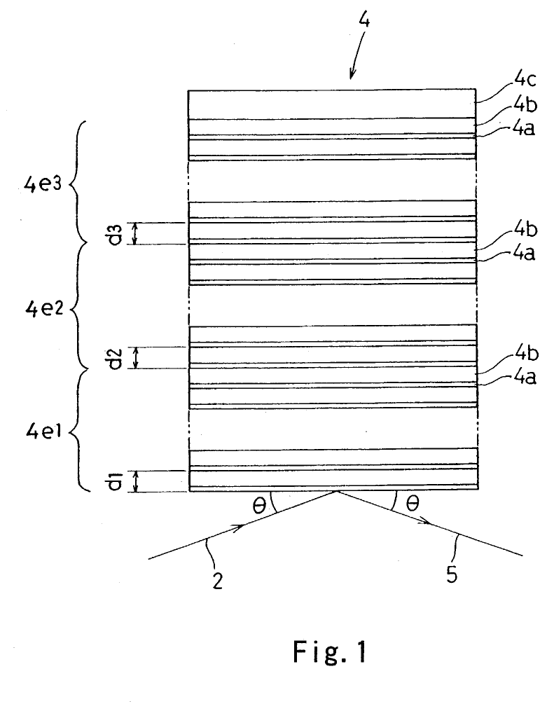

The X-ray monochromator 4, which itself constitutes a preferred embodiment of the present invention, is used in the X-ray fluorescence analysis for monochromating the X-rays 2, emitted from the X-ray tube 3, to provide the primary X-rays 5 that are subsequently emitted towards the sample surface. As shown in FIG. 1, this X-ray monochromator 4 is formed by depositing a plurality of layer pairs on a substrate 4c and each being made up of a reflecting layer 4a and a spacer layer 4b, wherein there is provided a plurality of multilayered films 4e including one or a plurality of layer pairs having a predetermined periodic length d, wherein the closer multilayered film 4e is to the substrate 4c, the smaller is set the above described predetermined periodic length d. In the illustrated embodiment, each of the reflecting layers 4a of these layer pairs 4e is made of tungsten (W) and each of the spacer layers 4b of these layer pairs 4e is made of silicon (Si), but they may not be limited thereto. The ratio of layer thickness between each reflecting layer 4a and spacer layer 4b may also not be limited to a particular value. As regards the shape, while the X-ray monochromator 4 is shown as a flat plate configuration, it may be curved. Where the X-ray monochromator is curved in shape, it is well known in the art to vary the periodic length d in the direction along the curvature thereof so that in one multilayered film (i.e., the multilayered film having a constant periodic length in a direction of depth thereof) the X-rays of the same energy can be reflected from different portions of the X-ray monochromator in the direction of curvature, and this known technique can be applied to the present invention.

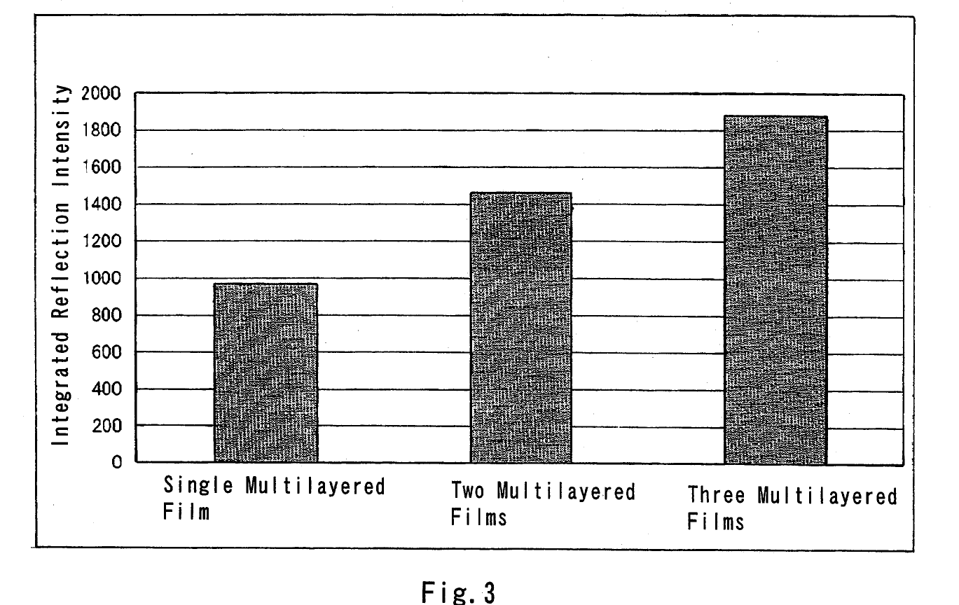

With respect to the X-ray monochromator utilizing the W/Si multilayered films, results comparison of simulated calculation of the integrated reflection intensity, exhibited by the X-ray monochromator of the present invention in which the number of the multilayered films is two and three, with that exhibited by the conventional X-ray monochromator having a single multilayered film, when by both X-ray monochromators continuous X-rays of 20,000 to 30,000 eV are monochromated, are shown in the chart of FIG. 3. The conventional X-ray monochromator used in the simulated calculation and having the single multilayered film is of a design in which 20 laminations of layer pairs each made up of a reflecting layer of 12.5 Å in thickness and a spacer layer of 17.5 Å in thickness and, hence, having a periodic length of 30 Å are deposited on a Si substrate. On the other hand, the X-ray monochromator of the present invention used in the simulated calculation and having the two multilayered films is of a design in which 20 laminations of the layer pairs each made up of the reflecting layer of 12.5 Å in thickness and the spacer layer of 15.5 Å in thickness and, hence, having a periodic length of 28 Å are disposed between the Si substrate and the multilayered film of the X-ray monochromator having a single multilayered film. The X-ray monochromator of the present invention similarly used in the simulated calculation and having the three multilayered films is of a design in which 40 laminations of the layer pairs each made up of the reflecting layer of 12.5 Å in thickness and the spacer layer of 14 Å in thickness and, hence, having a periodic length of 26.5 Å are disposed between the Si substrate and the multilayered film of 28 Å in periodic length of the X-ray monochromator having two multilayered films. During the simulated calculation, the angle of incidence of the X-rays onto each of those X-ray monochromator was chosen to be 0.5 degree.

According to the chart shown in FIG. 3, with the two multilayered films, the integrated reflection intensity is about 1.5 times that exhibited by the conventional X-ray monochromator and, with three multilayered films, the integrated reflection intensity is about two times that exhibited by the conventional X-ray monochromator. Thus, considering manufacturing ease to be achieved, the number of the multilayered films is preferably within the range of two to 4. On the other hand, as regards the number of the layer pairs forming each multilayered film, it may be one, that is, it may be possible to construct the multilayered film having a single layer pair. However, since it has been found that if all of the multilayered films is constructed of a single layer pair by all means, the energy resolution as a whole tends to be lowered, it is preferred that all these multilayered films are made up of a plurality of the layer pairs such as in the X-ray monochromator having the two or three multilayered films.

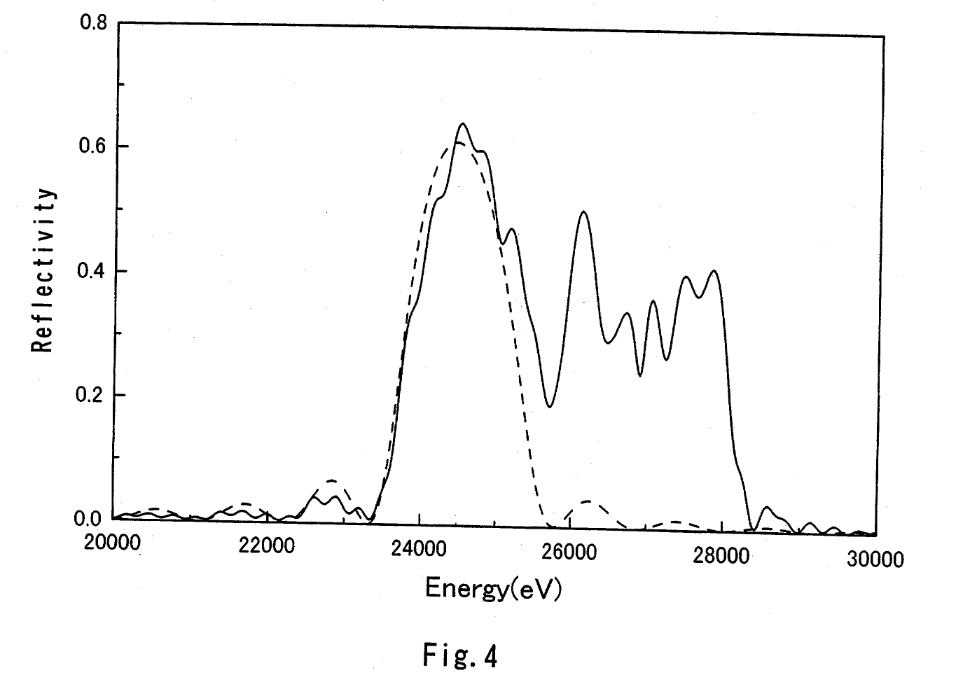

Also, in a manner similar to FIG. 3, using the X-ray monochromator of the present invention having the three multilayered film and the conventional X-ray monochromator having the single multilayered film, simulated calculation is made to determine the reflectivity exhibited when continuous X-rays of 20,000 to 30,000 eV were monochromated. In the chart of FIG. 4 results of comparison between the reflectivity exhibited by the X-ray monochromator of the present invention (continuous line) and that exhibited by the conventional X-ray monochromator (dashed line) are shown. According to the chart, it is clear that addition of these two multilayered films each having a small periodic length is effective to expand the energy range (energy width) of the X-rays, which can be reflected, towards a high energy side.

From the foregoing results of study, the X-ray monochromator having the three multilayered films as hereinabove described was fabricated for the purpose of the preferred embodiment of the present invention. In other words, referring to FIG. 1, in each of the three multilayered films 4e1, 4e2 and 4e3, although the periodic length is of a constant value, the periodic lengths of these multilayered films 4e1, 4e2 and 4e3 are so chosen as to progressively increase in the order from one of the multilayered films that is closest to the substrate 4c, that is, the multilayered film 4e3 to the multilayered film 4e1 remotest from the substrate 4c. In other words, the respective periodic lengths d1, d2 and d3 of the multilayered films 4e1, 4e2 and 4e3 are so chosen as to satisfy the relationship of d3(26.5 Å)<d2(28 Å)<d1(30 Å). On the other hand, for comparison purpose, the X-ray monochromator having the single multilayered film as discussed above was used as the conventional X-ray monochromator.

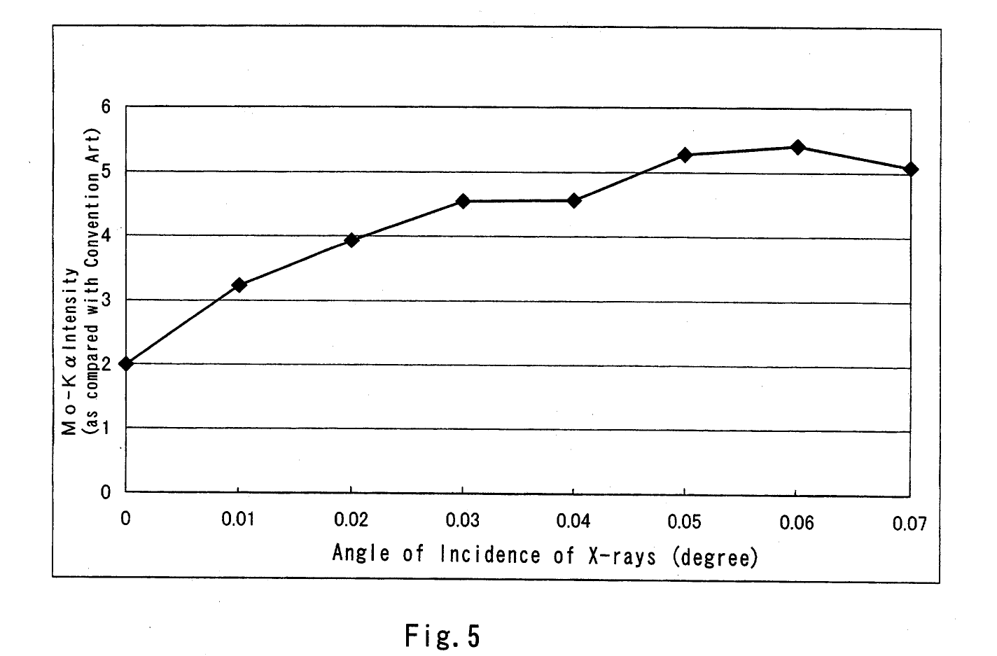

Using the total reflection X-ray fluorescence spectrometer of the structure shown in FIG. 2, the X-rays 2 emitted from the X-ray tube 3 having the tungsten target were monochromated by each of the X-ray monochromators and, using the monochromated continuous X-rays as the primary X-rays 5, the intensity of Mo—Kα line emitted from the sample 1, which is a silicon wafer having Mo (molybdenum) deposited thereon, was measured with the SSD 8 by irradiating the sample 1 with the primary X-rays 5 at a varying angle α of incidence. The relationship between the ratio of the measured intensity exhibited by the X-ray monochromator 4 of the present invention relative to that exhibited by the conventional X-ray monochromator and the angle α of incidence is shown in FIG. 5. According to the chart of FIG. 5, it is clear that since the integrated intensity of the primary X-rays 5 monochromated by the X-ray monochromator 4 of the preferred embodiment of the present invention is sufficiently high, Mo—Kα line 7 to be analyzed can be detected in an intensity that is two to five times that measured with the conventional X-ray monochromator. Also, since the limit of detection in such case improves to 0.544 in terms of the ratio relative to the conventional X-ray monochromator, it is clear that the primary X-rays 5 are properly monochromated.

As hereinabove fully described, with the X-ray monochromator 4 of the illustrated embodiment, the three multilayered films 4e1, 4e2 and 4e3 having the different periodic lengths in the direction of depth thereof can reflect X-rays of different energies. Also, since the closer multilayered film is to the substrate 4c, the smaller is set the periodic length, that is, d3<d2<d1, the X-rays having so small an energy as to be easily absorbed are reflected at a location rather shallow from the surface upon which such X-rays impinge, the efficiency of reflection as a whole is high. Accordingly, at about 24,000 to 28,000 eV, for example, the primary X-rays 5 which have been properly monochromated with a sufficiently high integrated intensity as a whole can be provided and, therefore, not only can Mo—Kα line be actually measured in an intensity that is about two to five times that with the conventional X-ray monochromator, but the limit of detection can also be improved to 0.544 in terms of the ratio with the conventional X-ray monochromator. Such meritorious effects are eminent particularly where the continuous X-rays are used as the primary X-rays. The X-ray fluorescence spectrometer according to this illustrated embodiment can bring about such meritorious effects, too.

Although the present invention has been fully described in connection with the preferred embodiment thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

What is claimed is:

1. An X-ray monochromator for use in a X-ray fluorescence analysis for monochromating X-rays, emitted from an X-ray source, to provide primary X-rays that are subsequently emitted towards a sample, said X-ray monochromator comprising:
a plurality of layer pairs deposited on a substrate, each of the layer pairs being made up of a reflecting layer and a spacer layer; with a plurality of multilayered films including one or a plurality of layer pairs having a predetermined periodic length, wherein the closer multilayered film is to the substrate, the smaller is set the predetermined periodic length.

2. The X-ray monochromator as claimed in claim 1, wherein the number of the multilayered films is within the range of 2 to 4 and each of all these multilayered films is made up of a plurality of layer pairs.

3. An X-ray fluorescence spectrometer which comprises:
an X-ray irradiating unit for irradiating a sample with primary X-rays, which have been monochromated by the X-ray monochromator as defined in claim 1; and
a detecting unit for measuring an intensity of fluorescent X-rays emitted from the sample.
